(19) United States
(12) Patent Application Publication
(10) Pub. No.: US 2019/0352193 A1
(43) Pub. Date: Nov. 21, 2019

(54) Device for the Purification of Water Using a Heat Pump

(71) Applicant: LabStrong Corp., Dubuque, IA (US)

(72) Inventors: Mark David Lockwood, Dubuque, IA (US); Joseph Paul Kearney, Dubuque, IA (US)

(73) Assignee: LabStrong Corp., Dubuque, IA (US)

(21) Appl. No.: 16/529,559

(22) Filed: Aug. 1, 2019

Related U.S. Application Data
(63) Continuation of application No. 15/615,185, filed on Jun. 6, 2017.
(60) Provisional application No. 62/484,462, filed on Apr. 12, 2017.
(60) Provisional application No. 62/345,951, filed on Jun. 6, 2016.

(51) Int. Cl. C02F 1/04; F25B 30/06; F25B 30/02; F25D 31/00; B01D 3/00; C09K 5/04

(52) U.S. Cl. CPC C02F 1/043; C02F 1/048; C02F 1/041; F25B 30/06; B01D 1/28; F25D 31/005; B01D 3/007; C09K 5/041; Y02B 30/52; F25B 30/02

(57) ABSTRACT

Disclosed herein are devices for the purification of water that use a heat pump. The purification system comprises a heat pump and the heat pump comprises a refrigerant condenser, a refrigerant evaporator, a compressor, and a throttle valve that are fluidly connected with a circulating refrigerant along a refrigerant line. The circulating refrigerant transfers heat to a contaminated feedstock at the refrigerant condenser to vaporize at least a portion of the contaminated feedstock. Also disclosed are methods of purifying water, washing systems comprising a washer and a water purification system, washing and drying systems comprising a washer, a dryer, and a water purification system, and methods for cleaning and/or drying of clothes.

### CROSS REFERENCE TO RELATED PATENT APPLICATIONS

This application claims benefit of priority to U.S. Provisional Application No. 62/484,462, filed on 12 Apr. 2017, and U.S. Provisional Application No. 62/345,951, filed on 6 Jun. 2016, the contents of which are incorporated herein by reference in their entirety.

### BACKGROUND

Fresh water is a limited and valuable resource that is needed by humans and animals alike. In the US, groundwater is the source of drinking water for half of the total population and nearly all the rural population while agriculture draws out over 50 billion gallons per day. And in many areas, we are now withdrawing water from ground aquifers faster than they replenish, which raises major environmental concerns since these diminishing aquifers no longer naturally supply wetlands, rivers and lakes.

Attempts to purify water are often rely on distillation methods. Those methods, however, are often energy inefficient and wasteful of water. Modern water distillation systems typically use a heating element to boil water and condense it again with the help of a stream of cooling water. The cooling water, which is normally drinking-water quality or better, is dumped down the drain. The energy used to boil the water is lost to the surroundings as heat. Even so, distillation remains a popular method for purifying water for two reasons: distillation removes more impurities than any other single method of water purification, and distillation is relatively maintenance-free.

As a result, the world needs devices and methods of water purification that are as effective as distillation, but make more efficient use of energy and clean water. In what follows, we describe just such a system.

### SUMMARY OF THE INVENTION

Disclosed herein are devices for the purification of water that use a heat pump. One aspect of the invention is a purification system comprising a heat pump. The heat pump comprises a refrigerant condenser, a refrigerant evaporator, a compressor, and a throttle valve that are fluidly connected with a circulating refrigerant along a refrigerant line. The circulating refrigerant transfers heat to a contaminated feedstock at the refrigerant condenser to vaporize at least a portion of the contaminated feedstock. In some embodiments, the circulating refrigerant receives heat from the vaporized contaminated feedstock at the refrigerant evaporator to condense at least a portion of vaporized contaminated feed stream to prepare a distillate. In other embodiments, the circulating refrigerant receives heat from a condensing liquid at the refrigerant evaporator to prepare a chilled condensing liquid and the chilled condensing liquid receives heat from the vaporized contaminated feedstock to condense at least a portion of the vaporized contaminated feedstock.

Another aspect of the invention is a purification system comprising an intake line for providing a contaminated feed stream to a distillation vessel, a refrigerant condenser in thermal communication with the contaminated feed stream within the distillation vessel, an refrigerant evaporator in thermal communication with a vapor within the distillation vessel, and an effluent line for removing a distillate from the distillation vessel.

Another aspect of the invention is a purification system comprising a heat pump, a distillation vessel, an intake line for providing a contaminated feed stream to the distillation vessel, and an effluent line for removing a distillate from the distillation vessel. The heat pump comprises a refrigerant condenser in thermal communication with the contaminated feed stream within the distillation vessel, a refrigerant evaporator within the distillation vessel in thermal communication with a vapor within the distillation vessel, a compressor configured to increase the internal energy of a circulating refrigerant, and a throttle valve configured to decrease the internal energy of the circulating refrigerant. The refrigerant condenser, the refrigerant evaporator, and the throttle valve are fluidly connected with the circulating refrigerant along a refrigerant line. Heat from the circulating refrigerant at the refrigerant condenser is transferred to the contaminated feed stream to vaporize at least a portion of the contaminated feed steam. In some embodiments, heat from the vapor within the distillation vessel is transferred to the circulating refrigerant at the refrigerant evaporator to condense at least a portion of the vapor within the distillation vessel to prepare the distillate. In other embodiments, the circulating refrigerant receives heat from a condensing liquid at the refrigerant evaporator to prepare a chilled condensing liquid and the chilled condensing liquid receives heat from the vaporized contaminated feedstock to condense at least a portion of the vaporized contaminated feedstock.

Another aspect of the invention is a method of purifying a contaminated feed stream comprising transferring heat from a circulating refrigerant to the contaminated feed stream at a refrigerant condenser to vaporize at least a portion of the contaminated feed stream within a distillation vessel and transferring heat from a vapor to condense at least a portion of the vapor to prepare a distillate.

Another aspect of the invention is a method of purifying a contaminated feed stream comprising contacting the contaminated feed stream with a refrigerant condenser to vaporize at least a portion of the contaminated feed stream and contacting a vapor obtained from the contaminated feed stream with a refrigerant evaporator to obtain a distillate, wherein heat is transferred from a circulating refrigerant to the contaminated feed stream at the refrigerant condenser and wherein heat is transferred from the vapor to condense at least a portion of the vapor to prepare a distillate.

Another aspect of the invention is a washing system comprising a washer and a water-purification system, wherein the water-purification system comprises a heat pump, wherein the washing system is configured to receive purified water from the water purification system, and wherein the water-purification system is configured to receive contaminated water from the washer.

Another aspect of the invention is a method for the cleaning of clothes or other soiled items, the method comprising washing the clothes or other soiled items with a washing system, wherein the washing system comprises a washer and a water-purification system, and wherein the water purification system comprises a heat pump.

Another aspect of the invention is a washing and drying system comprising a washer, a dryer, and a water-purification system, wherein the water-purification system comprises a heat pump, wherein the washing system is configured to receive purified water from the water purification system, wherein the water-purification system is configured to receive contaminated water from the washer, and wherein heat is transferred from the heat pump to the dryer.

Another aspect of the invention is a method for the cleaning and drying of clothes or other soiled items, the method comprising washing the clothes or other soiled items with a washing and drying system and drying the clothes or other soiled items with the washing and drying system, wherein the washing and drying system comprises a washer, a dryer, and a water-purification system, and wherein the water purification system comprises a heat pump.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1A illustrates an exemplary embodiment of a water purification system comprising a heat pump.

FIG. 1B illustrates an energy balance schematic for a water-purification system.

FIG. 2 illustrates an exemplary embodiment of a water purification system comprising a heat pump.

FIG. 3A illustrates an exemplary embodiment of a water purification system comprising a heat pump that uses a condensing liquid.

FIG. 3B illustrates an exemplary embodiment of a water purification system comprising a heat pump that uses a condensing liquid.

FIG. 4A illustrates an exemplary embodiment of a water purification system integrated with a reverse osmosis system.

FIG. 4B illustrates an exemplary embodiment of a water purification system integrated with a reverse osmosis system.

FIG. 5A illustrates an exemplary embodiment of a washing system comprising a water purification system having a heat pump for recycling water.

FIG. 5B shows an energy balance schematic for an integrated washing and water-purification system.

FIG. 5C shows an energy balance schematic for an integrated washing and water-purification system with recycled rinse water.

FIG. 6A illustrates an exemplary embodiment of a washing-drying system comprising a water purification system having a heat pump for recycling water and providing heat for drying.

FIG. 6B shows an energy balance schematic for an integrated washing, drying, and water-purification system.

FIG. 7 illustrates an exemplary narrow-band R718 refrigeration cycle.

FIG. 8 shows pressure-temperature relationships for several refrigerants.

FIG. 9 shows coefficients of performance for several refrigerants.

### DETAILED DESCRIPTION OF THE INVENTION

Disclosed herein are devices and methods for the purification of water that use a heat pump. The devices disclosed herein are specifically tuned to distill water to produce water of high purity with the use of recycled coolant and an exceptionally low energy draw. Moreover the devices do not require pretreatment or posttreatment, and in a single step high-purity water may be produced while separating volatile gases, oils, salts, minerals, or solids. These technical achievements will save the limited resource of fresh water, which continues to be drawn from rapidly depleting fresh water aquifers.

The contaminated feed stream may be any aqueous feed stream comprising a contaminant. Contaminants include any physical, chemical, biological, radiological, or other substance in the feed stream other than water. Examples of contaminates include, but are not limited to, organic molecules and materials, volatile gases, salts, microbes, or radioactive materials. Because the devices and methods disclosed here may produce distillate products of ultra-high purity, even water suitable for human or animal consumption may be considered contaminated depending on the feed stream's makeup and or intended use for the distillate product. Examples of contaminated water include, but are not limited to, sea water, brackish water, fresh water, ground water, drinking water, greywater, blackwater, hydraulic fracturing blowback water, hydraulic fracturing formation water, or any water in need of remediation. The contaminated feed stock may comprise the contaminated feed stream and/or additional contaminates remaining within the distillation vessel.

The water purification systems described herein may be used in any number of applications. Nonlimiting examples of the use of embodiments of the water purification systems include the production of potable water for human or animal consumption, water sterilization, water recycling, production of purified water for laboratory use, or environmental water remediation. These diverse applications are all possible because the water purification system and methods described herein may purify water at rates of liters per hour to kiloliters per hour, including greater than 1 liter/hour, greater than 10 liters/hour, greater than 100 liters/hour, greater than 1000 liters/hour, greater than 10,000 liters/hour and any rate in between.

The devices and methods disclosed herein produce a high-purity distillate. The distillate may be suitable for drinking, agricultural, laboratory, or any other use where high-purity water may be of use. In some embodiments, the distillate may have a resistivity greater than 0.2 MΩ cm, greater than 1 MΩ cm, or greater than 4 MΩ cm. In some embodiments, the distillate may have a conductivity of less than 5 μS/cm, less than 1 μS/cm, less than 0.25 μS/cm, or less than 0.056 μS/cm. In some embodiments, the distillate has a total organic carbon (TOC) concentration of less than 200 μg/L or less than 50 μg/L. In some embodiments, the distillate may have a sodium concentration of less than 50 μg/L, less than 10 μg/L, less than 5 μg/L, or less than 1 μg/L. In some embodiments, the distillate may have a chloride concentration of less than 50 μg/L, less than 10 μg/L, less than 5 μg/L, or less than 1 μg/L. In some embodiments, the distillate may have a silica concentration of less than 500 μg/L or less than 3 μg/L. In some embodiments, the distillate may have any of the resistivity, conductivity, TOC concentration, sodium concentration, chloride concentration, or silica concentration described here. In certain embodiments, the distillate has a purity sufficient to be graded ASTM Type IV, ASTM Type III, or ASTM Type II.

The purification systems and methods for purifying a contaminated feedstock use a heat pump. The heat pumps comprise a refrigerant condenser, a refrigerant evaporator, a compressor, and a throttle valve. The systems are configured to transfer heat from a circulating refrigerant to the contaminated feedstock. The heat transfer vaporizes at least a portion of the contaminated feedstock. The vaporization prepares a vaporized contaminated feedstock that has a lower level of contamination that the feedstock because the amount of heat transferred will not be sufficient to vaporize all of the contaminants in the feedstock. Heat may be transferred from the vapor that causes at least a portion of the vapor to condense into a distillate that typically has a lower level of contamination than the vapor because the amount of heat transferred will not be sufficient to condense all of the contaminants of the vapor.

The purification systems and heat pumps may be configured in a number of different ways. Although the present disclosure provides a number of exemplary embodiments, those of skill in the art will recognize that the components may be configured in ways not specifically described.

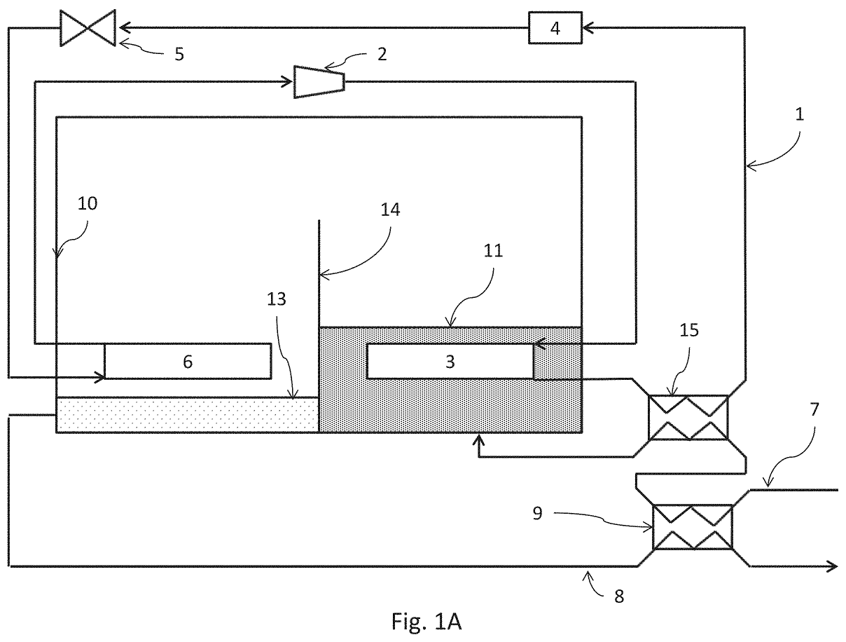

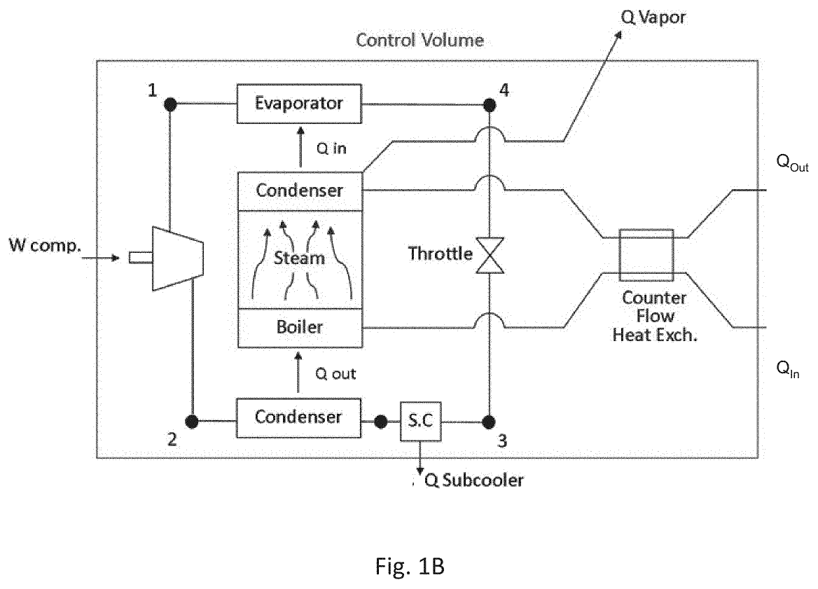

An exemplary embodiment of the invention is provided in FIG. 1A. As illustrated in FIG. 1A, the heat pump comprises a refrigerant line 1 fluidly connecting a compressor 2, a refrigerant condenser 3, an, optional, subcooler 4, a throttle valve 5 (i.e., variable expansion valve), and a refrigerant evaporator 6 with a circulating refrigerant. Within the heat pump, refrigerant is circulated by the compressor 2, which may be powered by an electric motor. Hot gaseous refrigerant leaves the compressor 2 and flows into the refrigerant condenser 3. The pressure at the exit of the compressor may be measured by a pressure sensor (not depicted). In the refrigerant condenser 3, heat is transferred from the refrigerant to the contaminated feedstock 11, causing the refrigerant to condense and the water to evaporate. The refrigerant moves to the subcooler 4, where heat is transferred to the surrounding environment by any suitable means of heat transfer. After the refrigerant leaves the subcooler 4, the pressure is reduced by the throttle valve 5, which also drops the temperature of the liquid refrigerant. This cool liquid refrigerant passes in to the refrigerant evaporator 6, where heat is transferred from the water vapor to the refrigerant, causing the refrigerant to evaporate and the water vapor to condense. The pressure of this gaseous refrigerant may be measured by the low pressure sensor (not depicted) before it enters the compressor to start the cycle over again.

A contaminated feed stream enters the system through the intake line 7 at a rate that may be controlled by the flow regulator (not depicted). This contaminated feed stream may be optionally warmed by the heat exchanger 9 and/or a preheater 15. The contaminated feed stream passes into the distillation vessel 10 and where the contaminated feedstock 11 is evaporated by the heat provided by the refrigerant condenser 3. The water vapor passes to the refrigerant evaporator 6, leaving impurities behind in the contaminated feedstock 11. After condensing on the refrigerant evaporator 6, distillate (i.e., purified liquid water) 13 is separated from the contaminated feedstock 11 by a partition 14 that allows for the migration of water vapor but prevents substantial remixing of the distillate 13 with the contaminated feedstock 11. To aid in the migration of water vapor, the distillation vessel may comprise a circulator (not depicted) to increase the rate of migration of the water vapor to the refrigerant evaporator 6. The distillate 13 exits the distillation vessel 10 by the effluent line 8. Heat may be transferred from the distillate flowing through the effluent line 8 to the incoming contaminated feedstock by an optional the heat exchanger 9.

The heat pump described herein may be any heat pump suitable for the distillation of water from a contaminated feedstock. Preferably, the heat pump is configured specifically to distill water. FIG. 1A illustrates the water purification system described above focusing on the energy balance. The water-cycle heat pump (“WCHP”) consists of a heat pump using refrigerant that drives a heat delta used to distill water. The control volume (outer boundary) has water entering and leaving at similar energy states; therefore, the amount of energy input through the compressor (Wcomp) must be removed as heat energy through the subcooler (Qsubcooler), or as uncondensed gasses through the gas vent (Qvapor). In an ideal system, Wcomp−Qsubcooler=0.

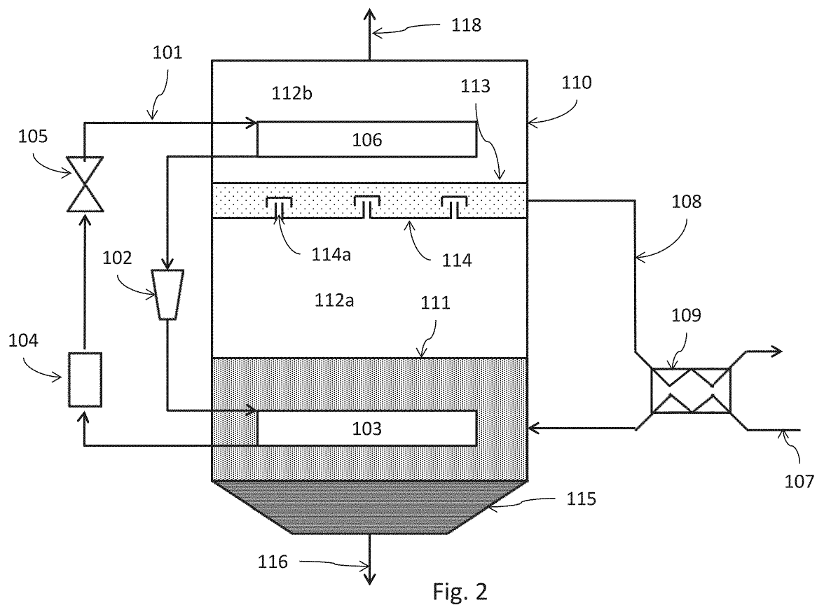

Another exemplary embodiment of the invention is illustrated in FIG. 2. As illustrated in FIG. 2, the heat pump comprises a refrigerant line 101 fluidly connecting a compressor 102, a refrigerant condenser 103, a subcooler 104, a throttle valve 105 (i.e., variable expansion valve), and a refrigerant evaporator 106 with a circulating refrigerant. Within the heat pump, refrigerant is circulated by the compressor 102, which may be powered by an electric motor. Hot gaseous refrigerant leaves the compressor 102 and flows into the refrigerant condenser 103. The pressure at the exit of the compressor may be measured by a pressure sensor (not depicted). In the refrigerant condenser 103, heat is transferred from the refrigerant to the contaminated feedstock 111, causing the refrigerant to condense and the water to evaporate. The refrigerant moves to the subcooler 104, where heat is transferred to the surrounding environment by any suitable means of heat transfer. After the refrigerant leaves the subcooler 104, the pressure is reduced by the throttle valve 105, which also drops the temperature of the liquid refrigerant. This cool liquid refrigerant passes in to the refrigerant evaporator 106, where heat is transferred from the water vapor to the refrigerant, causing the refrigerant to evaporate and the water vapor to condense. The pressure of this gaseous refrigerant may be measured by the low pressure sensor (not depicted) before it enters the compressor to start the cycle over again.

A contaminated feed stream enters the system through the intake line 107 at a rate that may be controlled by the flow regulator (not depicted). This contaminated feed stream may be optionally warmed by the heat exchanger 109. The contaminated feed stream passes into the distillation vessel 110 and where the contaminated feedstock 111 is evaporated by the heat provided by the refrigerant condenser 103. The water vapor passes to the refrigerant evaporator 106, leaving impurities behind. After condensing on the refrigerant evaporator 106, distillate 113 is collected via a collection plate 114 and exits the distillation vessel 110 by the effluent line 108. As shown, the collection plate has a plurality of bubble caps, e.g., bubble cap 114a, that allows for the water vapor to transfer from region 112a to region 112b but reduces the likelihood that the distillate 113 returns to the contaminated feedstock 111. A circulator (not shown) may be used to create a pressure differential between region 112a and 112b, preferably to have the pressure in region 112a lower than in 112b. Heat may be transferred from the distillate flowing through the effluent line 108 to the incoming contaminated feedstock 107 by an optional the heat exchanger 109.

Impurities may remain within the contaminated feedstock 111, may coalesce as dregs at the bottom of the distillation vessel 115, collect on the refrigerant condenser 103, or be volatized depending on the nature of the impurity. The impurities may be removed in several ways depending on the desired operation. The distillation vessel 110 may be run dry, allowing the impurities to be removed periodically as solid waste. Although this method most efficiently conserves water, this method also mandates downtime for the purification system. Alternatively, the distillation vessel 110 may be drained either continuously or periodically via an optional drain line 116, the draining of which may be controlled by a valve or a regulator (not depicted). Although this method may increase uptime, water will be less well conserved. As for the volatile gases, they may be vented continuously or periodically via an optional vent line 118, the venting of which may be controlled by a valve or a regulator (not depicted).

To facilitate the cleaning of the distillation vessel and/or removal of solid or concentrated feedstock, a liner may be fitted within the distillation vessel for the collection and removal of the solid or concentration feedstock. The liner may be formed from any suitable material, including for example, plastics, rubbers, or metals. Where a liner is used, the distillation vessel may have a sealable hatch suitable for extracting the liner and/or any material that may have been collected within the liner.

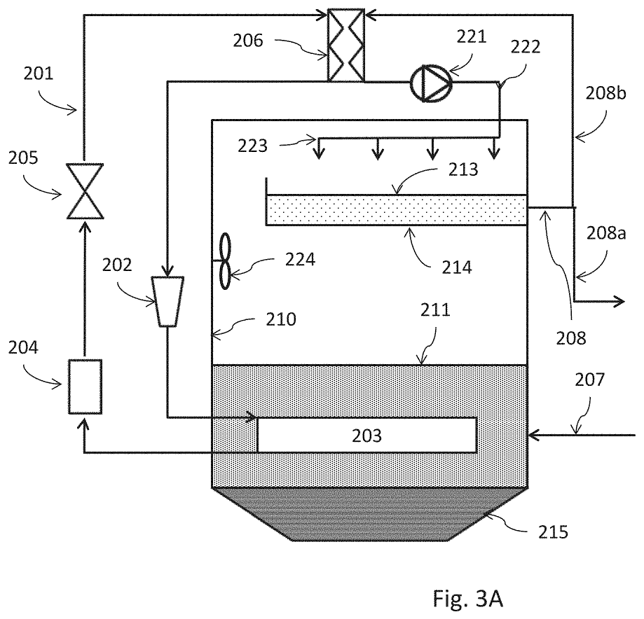

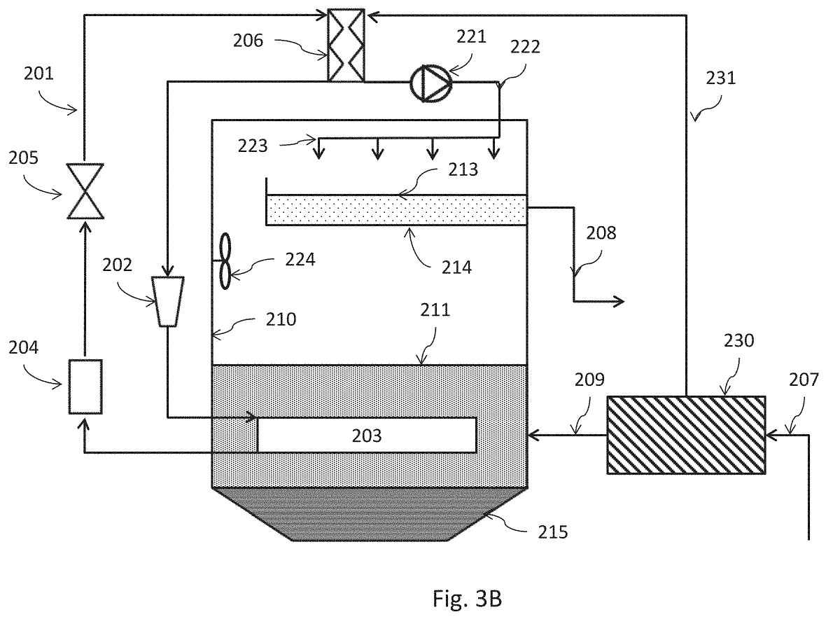

Another exemplary embodiment of the invention is illustrated in FIG. 3A. As illustrated in FIG. 3A, the heat pump comprises a refrigerant line 201 fluidly connecting a compressor 202, a refrigerant condenser 203, a subcooler 204, a throttle valve 205 (i.e., variable expansion valve), and a refrigerant evaporator 206 with a circulating refrigerant. Within the heat pump, refrigerant is circulated by the compressor 202, which may be powered by an electric motor. Hot gaseous refrigerant leaves the compressor 202 and flows into the refrigerant condenser 203. The pressure at the exit of the compressor may be measured by a pressure sensor (not depicted). In the refrigerant condenser 203, heat is transferred from the refrigerant to the contaminated feedstock 211, causing the refrigerant to condense and the contaminated feedstock to evaporate. The refrigerant moves to the subcooler 204, where heat is transferred to the surrounding environment by any suitable means of heat transfer. After the refrigerant leaves the subcooler 204, the pressure is reduced by the throttle valve 205, which also drops the temperature of the liquid refrigerant. This cool liquid refrigerant passes in to the refrigerant evaporator 206, where heat is transferred from a condensing liquid to the refrigerant, causing the refrigerant to evaporate and the condensing liquid to chill. The pressure of this gaseous refrigerant may be measured by the low pressure sensor (not depicted) before it enters the compressor to start the cycle over again.

A contaminated feed stream enters the system through the intake line 207 at a rate that may be controlled by the flow regulator (not depicted). This contaminated feed stream may be optionally warmed by the heat exchanger (not depicted). The contaminated feed stream passes into the distillation vessel 210 and where the contaminated feedstock 211 is evaporated by the heat provided by the refrigerant condenser 203. The chilled condensing liquid is ejected from a line 222 having at least one outlet 223. The vapor contacts the chilled condensing liquid, causing it to condense. After condensing, distillate 213 is collected via a collection plate 214 and exits the distillation vessel 210 by the effluent line 208. Impurities may remain within the contaminated feedstock 211, or may coalesce as dregs at the bottom of the distillation vessel 215. To aid in the migration of water vapor, the distillation vessel may comprise a circulator 224 to increase the rate of migration of the water.

The chilled condensing liquid may optionally be ejected from a line having a manifold of several outlets as depicted in FIG. 3. The line 222 may comprise an optional pump 221 for increasing the pressure of the chilled condensing liquid between the refrigerant evaporator 206 and an outlet. In certain embodiments, the pressure of the chilled condensing liquid in the line 222 is greater than the vapor pressure within the distillation vessel 210. As a result, the chilled condensing liquid injected into the distillation vessel via the outlet 223 may expand and further cool. A nozzle fitted at the outlet 223 may further facilitate the rapid expansion and cooling of the condensing liquid.

The condensing liquid preferably comprises water and may originate from any suitable source. As shown in FIG. 3A, the condensing liquid is distillate 213 flowing out of the distillation vessel 210 via line 208 is separated by two lines 208a and 208b. Line 208b is the effluent line while line 208b recycles the distillate as the condensing liquid back into the distillation vessel 210 via the refrigerant evaporator 206. Those of skill in the art will recognize that the condensing liquid may originate from other sources, including by not limited to water lines, tanks, or reverse osmosis systems.

An alternative embodiment is shown in FIG. 3B where the condensing liquid is a permeate from a reverse osmosis system 230. As shown, the contaminated feed stream first contacts the reverse osmosis system 230 where the contaminated feed stream via intake line 207 at a rate that may be controlled by a flow regulator. The contaminated feed stream passes into a reverse osmosis system 230 and where feed stream is segregated into a permeate and a concentrate by reverse osmosis. The permeate exits the reverse osmosis system 230 via line 231 where it can contact the refrigerant evaporator 206 to be used as the condensing liquid and contact the vapor within the distillation vessel 210, causing at least a portion of the vapor to condense and prepare the distillate 213. The concentrate exits the reverse osmosis system 230 via line 209 where it can be introduced to the distillation vessel 210 to be distilled using the heat pump.

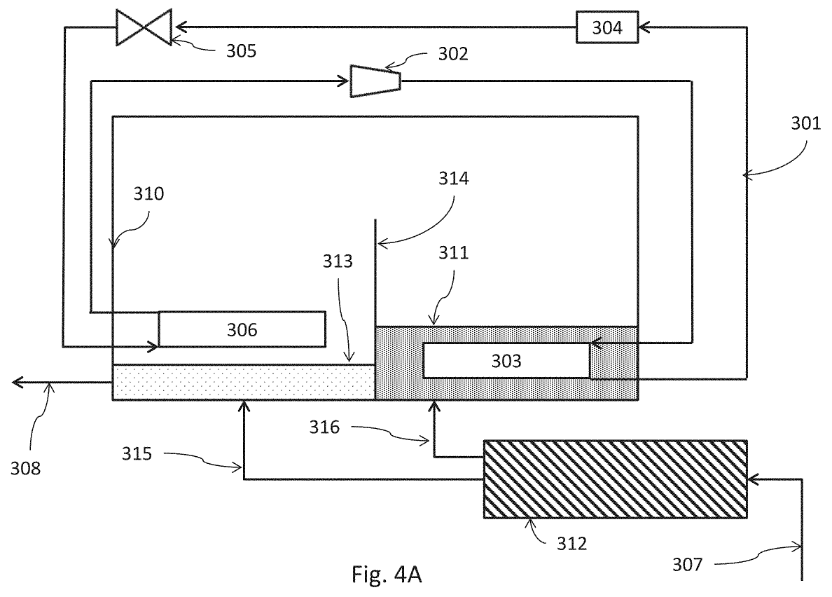

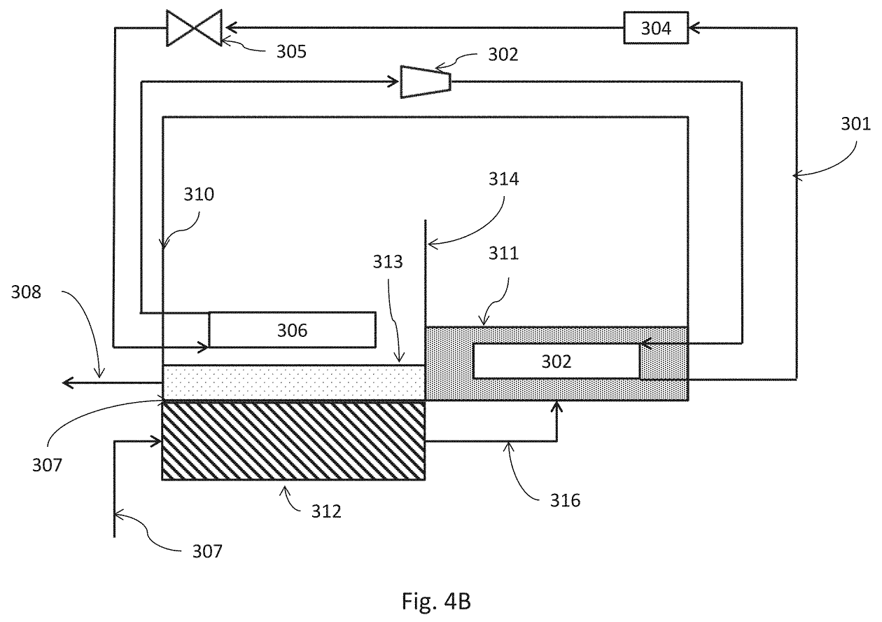

An exemplary embodiment of the invention integrated with a reverse osmosis membrane is provided in FIGS. 4A and 4B. Although the overall purity of the water may be lower than for other embodiments described above, it may allow for higher rates of feed stream processing and/or the production of potable water. As illustrated in FIG. 4A, the heat pump comprises a refrigerant line 301 fluidly connecting a compressor 302, a refrigerant condenser 303, an, optional, subcooler 304, a throttle valve 305 (i.e., variable expansion valve), and a refrigerant evaporator 306 with a circulating refrigerant. Within the heat pump, refrigerant is circulated by the compressor 302, which may be powered by an electric motor. Hot gaseous refrigerant leaves the compressor 302 and flows into the refrigerant condenser 303. The pressure at the exit of the compressor may be measured by a pressure sensor (not depicted). In the refrigerant condenser 303, heat is transferred from the refrigerant to the contaminated feedstock 311, causing the refrigerant to condense and the water to evaporate. The refrigerant moves to the subcooler 304, where heat is transferred to the surrounding environment by any suitable means of heat transfer. After the refrigerant leaves the subcooler 304, the pressure is reduced by the throttle valve 305, which also drops the temperature of the liquid refrigerant. This cool liquid refrigerant passes in to the refrigerant evaporator 306, where heat is transferred from the water vapor to the refrigerant, causing the refrigerant to evaporate and the water vapor to condense. The pressure of this gaseous refrigerant may be measured by the low pressure sensor (not depicted) before it enters the compressor to start the cycle over again.

A contaminated feed stream enters the system through the intake line 307 at a rate that may be controlled by the flow regulator (not depicted). The contaminated feed stream passes into a reverse osmosis system 312 and where feed stream is segregated into a permeate and a concentrate by reverse osmosis. The permeate exits the reverse osmosis system 312 via line 315 where it can be mixed with the distillate 313 within the distillation vessel 310, as shown, or any other appropriate place. The concentrate exits the reverse osmosis system 312 via line 316 where it can be introduced to the distillation vessel 310 to be distilled using the heat pump. The contaminated feedstock 311 is evaporated by the heat provided by the refrigerant condenser 303. The water vapor passes to the refrigerant evaporator FIG. 4A illustrates an exemplary embodiment of a water purification system integrated with a reverse osmosis system 306, leaving impurities behind in the contaminated feedstock 311. After condensing on the refrigerant evaporator 306, distillate (i.e., purified liquid water) 313 is separated from the contaminated feedstock 311 by a partition 314 that allows for the migration of water vapor but prevents substantial remixing of the distillate 313 with the contaminated feedstock 311. To aid in the migration of water vapor, the distillation vessel may comprise a circulator (not depicted) to increase the rate of migration of the water vapor to the refrigerant evaporator 306. The distillate, and possibly the permeate, 313 exits the distillation vessel FIG. 3A illustrates an exemplary embodiment of a water purification system integrated with a reverse osmosis system 310 by the effluent line 308.

In an alternative embodiment shown in FIG. 4B, the reverse osmosis system may be integrated into the water purification system by a semipermeable membrane 317 that allows for the permeate and the distillate to mix while also allowing for the distillate and the feed stream within the reverse osmosis system to thermally equilibrate. This may increase the temperature of the concentrate entering into the distillation vessel 310 via line 316 without the use of an additional heat exchanger.

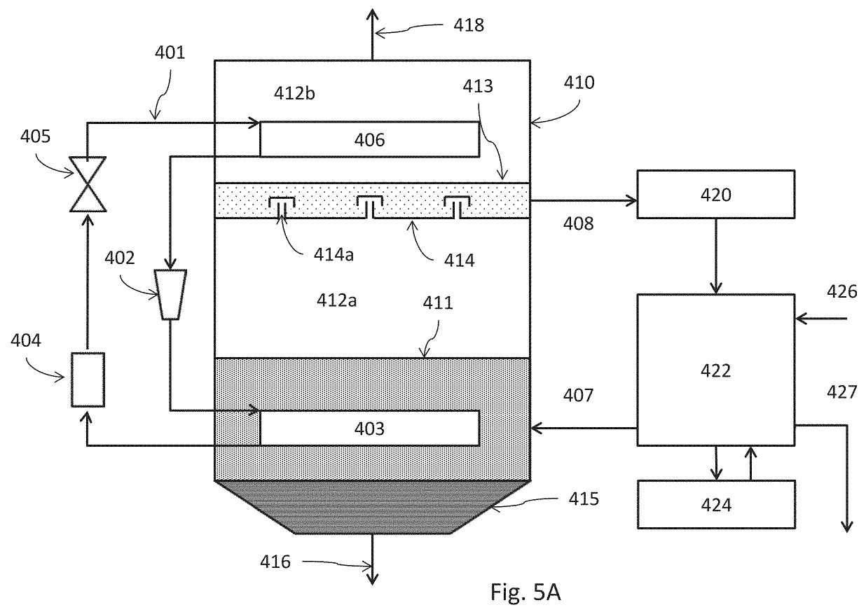

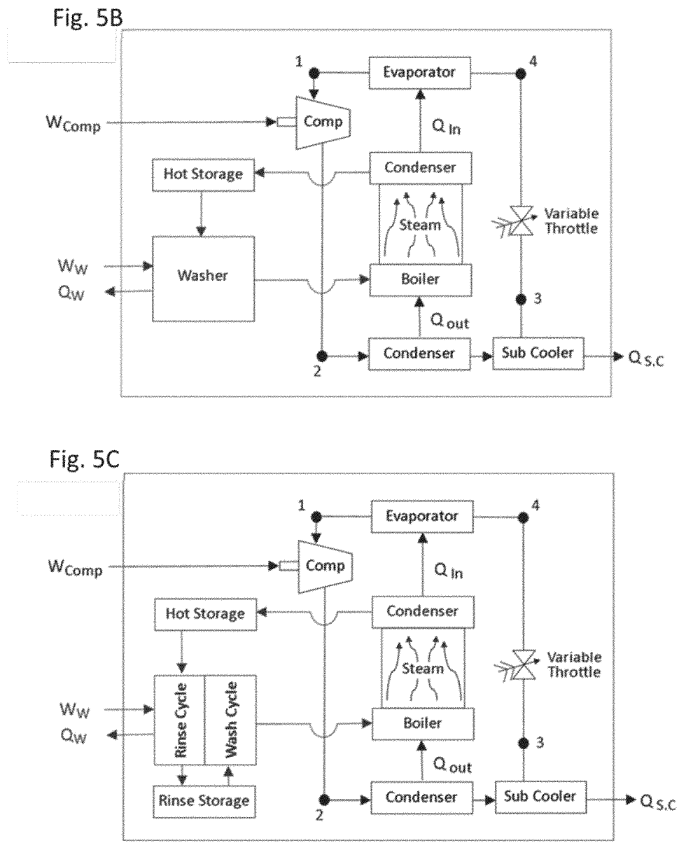

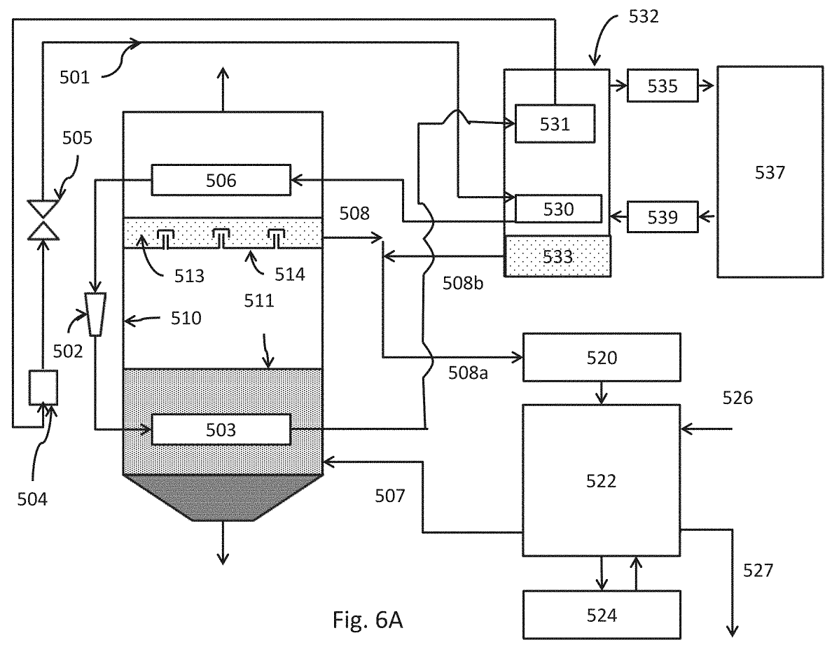

In another aspect of the invention, the water purification systems described herein may be used in combination with a washing machine that allows for the purification and recycle of greywater that results from washing. An exemplary embodiment of the invention is illustrated in FIG. 5A. As illustrated in FIG. 5A, the heat pump comprises a refrigerant line 401 fluidly connecting a compressor 402, a refrigerant condenser 403, a subcooler 404, a throttle valve 405 (i.e., variable expansion valve), and a refrigerant evaporator 406 with a circulating refrigerant. Within the heat pump, refrigerant is circulated by the compressor 402, which may be powered by an electric motor. Hot gaseous refrigerant leaves the compressor 402 and flows into the refrigerant condenser 403. The pressure at the exit of the compressor may be measured by a pressure sensor (not depicted). In the refrigerant condenser 403, heat is transferred from the refrigerant to the contaminated feedstock 411, causing the refrigerant to condense and the water to evaporate. The refrigerant moves to the subcooler 404, where heat is transferred to the surrounding environment by any suitable means of heat transfer. After the refrigerant leaves the subcooler 404, the pressure is reduced by the throttle valve 405, which also drops the temperature of the liquid refrigerant. This cool liquid refrigerant passes in to the refrigerant evaporator 406, where heat is transferred from the water vapor to the refrigerant, causing the refrigerant to evaporate and the water vapor to condense. The pressure of this gaseous refrigerant may be measured by the low pressure sensor (not depicted) before it enters the compressor to start the cycle over again.

A contaminated feed stream enters the system through the intake line 407 at a rate that may be controlled by a valve or flow regulator (not depicted). This contaminated feed stream may be optionally warmed by the heat exchanger (not depicted). The contaminated feed stream passes into the distillation vessel 410 and where the contaminated feedstock 411 is evaporated by the heat provided by the refrigerant condenser 403. The water vapor passes to the refrigerant evaporator 406, leaving impurities behind. After condensing on the refrigerant evaporator 406, distillate 413 is collected via a collection plate 414 and exits the distillation vessel 410 by the effluent line 408. As shown, the collection plate has a plurality of bubble caps, e.g., bubble cap 414a, that allows for the water vapor to transfer from region 412a to region 412b but reduces the likelihood that the distillate 413 returns to the contaminated feedstock 411. A circulator (not shown) may be used to create a pressure differential between region 412a and 412b, preferably to have the pressure in region 412a lower than in 412b. Heat may be transferred from the distillate flowing through the effluent line 408 to the incoming contaminated feedstock by an optional the heat exchanger (not depicted). The distillation vessel 410 may be drained either continuously or periodically via an optional drain line 416, the draining of which may be controlled by a valve or a regulator (not depicted). Although this method may increase uptime, water will be less well conserved. As for the volatile gases, they may be vented continuously or periodically via an optional vent line 418, the venting of which may be controlled by a valve or a regulator (not depicted).

The washing system is integrated with the water purification system via the contaminated feedstream line 407 and the effluent line 408. This integration allows for purified water to be transferred to the washing system while grey water is returned from the washing system to the distillation vessel for subsequent purification. The distillate 413 that exits the distillation vessel 410 may be transferred to a storage tank 420 where it can be collected and stored before being transferred to a washer 422, the flow of which may be regulated by a valve or a flow regulator (not depicted). In some embodiments, the storage tank is an insulated storage tank. The water from the storage tank 420 may be introduced at any stage in the wash cycle. Following the wash cycle, the washer 422 may be drained via line 407 and recycled to the distillation vessel 410 for subsequent purification. The washer 422 may otherwise be drained via line 427. Water may be added to the system via line 426 that introduces the water directly to the washer 422, as shown. However, water may be introduced at any suitable point, for example directly into line 407, depending on the quality of the water to be introduced.

In some embodiments, the water from the storage tank 420 is introduced during a rinse cycle. Following the rinse cycle, the water may be drained to a secondary storage tank 424 to be collected and stored before being transferred back to the washer 422 for a subsequent wash cycle, preferably before a final rinse cycle.

FIGS. 5B and 5C illustrates an energy balance schematic for washing system integrated with a water purification system. FIG. 5B depicts a washing system having only a hot storage tank. FIG. 5C depicts a washing system having a hot storage tank and a rinse storage tank. The black lines indicate the flow of refrigerant used to move heat between the gray water boiler chamber and the condenser chamber. The heat pump consists of a compressor, condenser, subcooler, variable throttle and an evaporator. The blue lines indicate the flow of the laundry water. The water enters the washer and is pumped out into the gray water boiler chamber where it evaporates into steam. The steam phase changes back to liquid in the condenser chamber where purified water is gravity fed back into the hot storage tank where it remains until the washer cycle calls for additional water. The red lines indicate the control volume for energy balance equation. This simplified system has balanced inputs and outputs. The compressor work input (Wcomp) would equal the heat dumped by the subcooler (Qsc). Similarly, the work washer input (Ww), which powers the motors and controls, creates heat which is dissipated back out of the control volume as Qw.

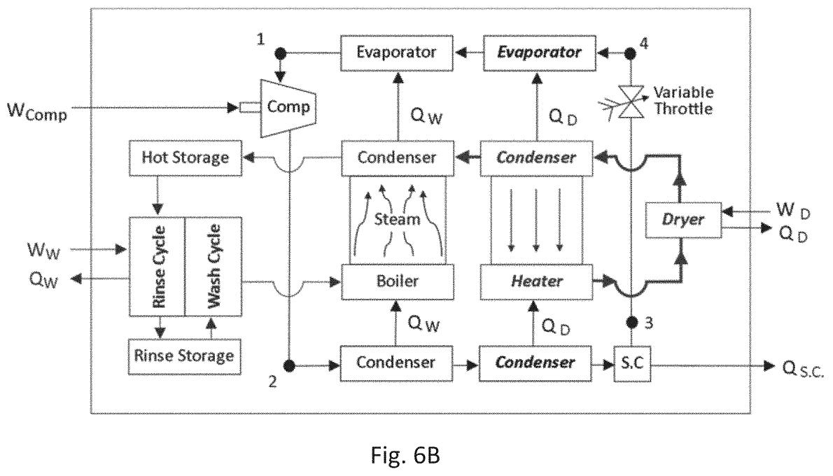

In another aspect of the invention is a washing and drying system where the water purification systems described herein may be used in combination with a washing machine and a dryer that allows for the purification and recycle of greywater that results from washing and that allows for heat to be transferred from the heat pump to the dryer. An exemplary embodiment of the invention is illustrated in FIG. 6A. As illustrated in FIG. 6A, the heat pump comprises a refrigerant line 501 fluidly connecting a compressor 502, a refrigerant condenser 503, a subcooler 504, a throttle valve 505 (i.e., variable expansion valve), and a refrigerant evaporator 506 with a circulating refrigerant. Within the heat pump, refrigerant is circulated by the compressor 502, which may be powered by an electric motor. Hot gaseous refrigerant leaves the compressor 502 and flows into the refrigerant condenser 503. The pressure at the exit of the compressor may be measured by a pressure sensor (not depicted). In the refrigerant condenser 503, heat is transferred from the refrigerant to the contaminated feedstock 511, causing the refrigerant to condense and the water to evaporate. The circulating refrigerant may engage with the integrated drying system by proceeding to a second refrigerant condenser 530, causing further refrigerant condensation while warming air to be used by the dryer. The refrigerant moves to the subcooler 504, where heat is transferred to the surrounding environment by any suitable means of heat transfer. After the refrigerant leaves the subcooler 504, the pressure is reduced by the throttle valve 505, which also drops the temperature of the liquid refrigerant. The cool circulating refrigerant may engage with the integrated drying system by proceeding to a second refrigerant evaporator 530, causing refrigerant evaporation while condensing water from moist air from the dryer. The liquid refrigerant may also pass into the refrigerant evaporator 506, where heat is transferred from the water vapor to the refrigerant, causing the refrigerant to evaporate and the water vapor to condense. The pressure of this gaseous refrigerant may be measured by the low pressure sensor (not depicted) before it enters the compressor to start the cycle over again.

A contaminated feed stream enters the system through the intake line 507 at a rate that may be controlled by a flow regulator (not depicted). This contaminated feed stream may be optionally warmed by the heat exchanger (not depicted). The contaminated feed stream passes into the distillation vessel 510 and where the contaminated feedstock 511 is evaporated by the heat provided by the refrigerant condenser 503. The water vapor passes to the refrigerant evaporator 506, leaving impurities behind. After condensing on the refrigerant evaporator 506, distillate 513 is collected via a collection plate 514 and exits the distillation vessel 510 by the effluent line 508. Heat may be transferred from the distillate flowing through the effluent line 508 to the incoming contaminated feedstock 507 by an optional the heat exchanger (not depicted).

The washing system is integrated with the water purification system via the contaminated feedstream line 507 and the effluent line 508a. This integration allows for purified water to be transferred to the washing system while greywater is returned from the washing system to the distillation vessel for subsequent purification. The distillate 513 that exits the distillation vessel 510 may be transferred to a storage tank 520 where it can be collected and stored before being transferred to a washer 522, the flow of which may be regulated by a valve or a flow regulator (not depicted). The water from the storage tank 520 may be introduced at any stage in the wash cycle. In some embodiments, the storage tank is an insulated storage tank. Following the wash cycle, the washer 522 may be drained via line 507 and recycled to the distillation vessel 510 for subsequent purification. The washer 522 may otherwise be drained via line 527. Water may be added to the system via line 526 that introduces the water directly to the washer 522, as shown. However, water may be introduced at any suitable point, for example directly into line 507, depending on the quality of the water to be introduced.

In some embodiments, the water from the storage tank 520 is introduced during a rinse cycle. Following the rinse cycle, the water may be drained to a secondary storage tank 524 to be collected and stored before being transferred back to the washer 522 for a subsequent wash cycle, preferably before a final rinse cycle.

The dryer system is integrated with the water purification system via the heat pump system. This integration allows for excess heat to be used to warm and dehydrate moist air exiting a dryer. This integration is accomplished by adding a second refrigerant condenser 531 and a second refrigerant evaporator 530 to the refrigerant line. In one embodiment, the second refrigerant condenser 531 is positioned between the refrigerant condenser 503 and the subcooler 504 along the refrigerant line 501, as shown in FIG. 6. In another embodiment, the second refrigerant condenser is positioned between the compressor and the refrigerant condenser of the distillation vessel along the refrigerant line. In one embodiment, the second refrigerant evaporator 530 is positioned between the throttle valve 505 and the refrigerant condenser 506 along the refrigerant line 501, as shown in FIG. 6. In another embodiment, the second refrigerant evaporator is positioned between the refrigerant evaporator of the distillation vessel and the compressor along the refrigerant line. In a housing 532, moist air from the dryer 537 will contact the refrigerant evaporator 530 where heat will be transferred from the moist air to the refrigerant evaporator 530 causing the moisture to condense to prepare a distillate 533. The distillate may be collected and exist the housing 532 via effluent line 508b. Effluent line may optionally join with effluent line 508 to combine distillates 513 and 533 in line 508a. The air within the housing 532 may contact the second refrigerant condenser 531 where heat is transferred from the circulating refrigerant to the warm the air. Warm air exits the housing 532 where it may optionally contact a heater 535 to further increase the temperature of the warm dry air before being transferred to the dryer 537. After the warm dry air contacts with the wet materials to be dried, the air cools and absorbs moisture. This moist cool air may be transferred back to the housing 532, where an optional blower 539 may facilitate transfer of the cool moist air to the blower.

FIG. 6B illustrates an energy balance schematic for the components in FIG. 6A. This air driven cycle consists of a dryer, a condenser that turns water vapor into recycled water, and a heat exchanger to re-heat the returning dryer air. The control volume has two additional balanced power exchanges with WD (electrical power to run dryer) and QD (the heat dumped from that same power consumption).

With the appropriate choice of refrigerant, the WCHP has the ability to operate as a fractional distiller within a narrow temperature band tuned selectively for water liquid/vapor exchange. By varying the refrigerant charge, the compressor speed, and the variable throttle, the user can select the operational temperature driving the evaporation chamber, and the operational temperature driving the steam condensation chamber.

As used herein, “distill” means to separate components or substances from a liquid mixture by selective evaporation and condensation and “distillate” means the product formed by distilling. Although the contaminated feedstock may be distilled at temperatures causing the contaminated feedstock to boil, it need not be. Depending on the type of contaminants present in the feedstock and/or their concentration, it may be preferable to distill the contaminated feed stock below its boiling point.

The refrigerant condenser may be at any suitable temperature to increase the partial pressure of water from the contaminated feedstock. As a result, the evaporation of water from the contaminated feedstock may be driven by a refrigerant condenser at 50° C. or greater. In some embodiments, the refrigerant condenser may be at a temperature of greater than 50° C., 55° C., 60° C., 65° C., 70° C., 75° C., 80° C., 85° C., 90° C., 95° C., 100° C., 105° C., 110° C., 115° C., 120° C., 125° C., 130° C., 135° C., 140° C., 145° C., or 150° C. Even higher temperatures may be used provided that suitable structures within the distillation vessel are employed to reduce the amount of impurities ejected into the vapor phase and contacted with the refrigerant evaporator. For example, baffles within the distillation vessel may be employed to minimize the amount of particulates and/or aerosols contacting the refrigerant evaporator.

The refrigerant evaporator may be at any suitable temperature to condense at least a portion of the water in the vapor. As a result, the refrigerant evaporator may be at a temperature of 100° C. or less. In some embodiments, the refrigerant evaporator is at a temperature less than 100° C., 95° C., 90° C., 85° C., 80° C., 75° C., 70° C., 65° C., 60° C., 55° C., 50° C., 45° C., 40° C., 35° C., 30° C., 25° C., 20° C., 15° C., 10° C., or 5° C.

The temperature difference between the refrigerant condenser and the refrigerant evaporator may be any suitable temperature difference that allows for the production of a distillate. In some embodiments, the temperature difference is between 5° C. and 140° C. In particular embodiments, the temperature different is between 5° C. and 50° C., 5° C. and 40° C., 5° C. and 30° C., 10° C. and 50° C., 10° C. and 40° C., 10° C. and 30° C., 15° C. and 50° C., 15° C. and 40° C., or 15° C. and 30° C.

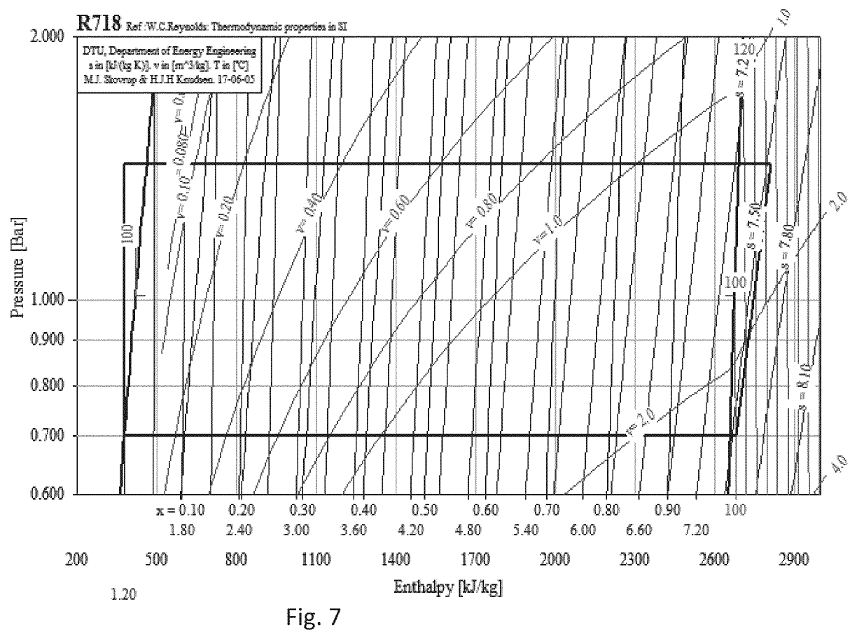

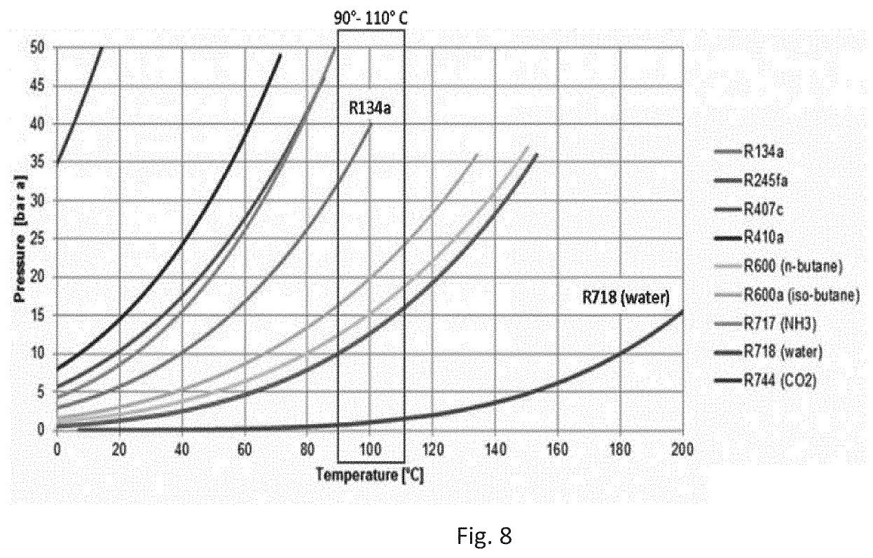

In some embodiments, the refrigerant is R718, i.e., water. An exemplary narrow band R718 cycle is indicated in blue in FIG. 7 and includes the heat and work power for the system. R718 can operate at a much higher temperature and much lower pressures than many common refrigerants, e.g., R134a. R718 is a very efficient refrigerant due to its very high latent heat of evaporation (2,270 kJ/kg), which is more than ten times higher than the latent heat of vaporization of R134a (215.9 kJ/kg). R718 has a higher triple point than R134a. R134a's triple point happens to be very near the boiling point of water, which means that the theoretical coefficient of performance (“COP”) efficiencies of R134a operating near the boiling point of water are insignificant. R134a is operating at high pressure requiring wide pressure deltas due to its steep P-T curve. In contrast, R718 can operate at much higher temperatures and with much lower pressure deltas. See, FIG. 8. In addition to high temperatures at very low pressures, R718 releases uniquely high heat capacity during phase change. Therefore, R718 is uniquely efficient at the boiling temperatures required to distill water. This, in turn, makes a R718 heat pump extremely efficient. Therefore, R718 can move significantly more heat per kg than R134a.

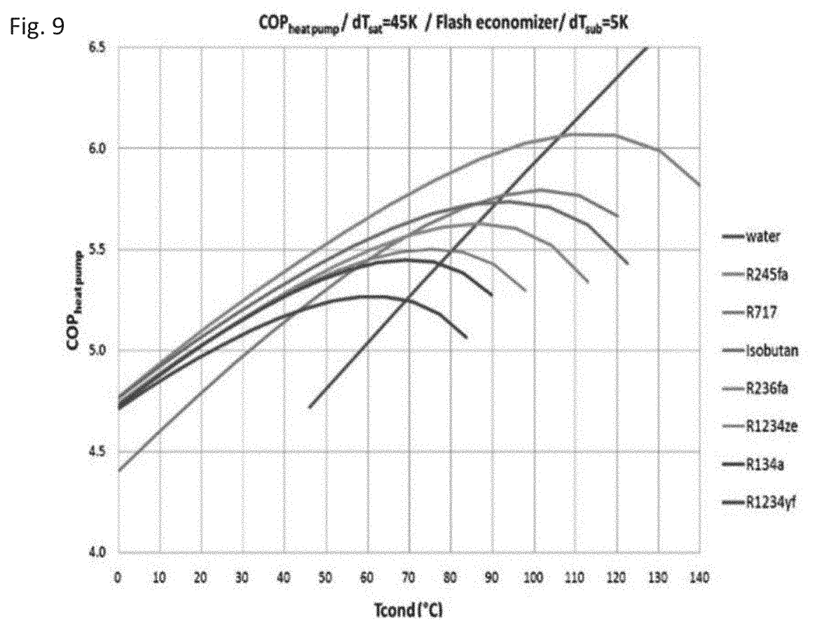

In other embodiments, the refrigerant may be a refrigerant other than water. The refrigerant may have one or more of the following properties: a high latent heat of evaporation, a high heat capacity during phase change, a high triple point, and/or may operate at high temperatures at low pressure. Examples of other refrigerants for use with the heat pumps disclosed herein include, without limitation, R134a (1,1,1,2-tetrafluoroethane), R245fa (1,1,1,3,3-pentafluoropropane), R717 (ammonia), R600a (isobutene), and R236fa (1,1,1,3,3,3-hexafluoropropane). See, FIGS. 8 and 9.

The compressor may be any compressor suitable for use with a heat pump to compress a refrigerant. In some embodiments, the compressor is configured to compress an R718 refrigerant. In other embodiments, the compressor is configured to compress a refrigerant having one or more of the properties described above. In certain embodiments, the compressor is corrosion resistant for the refrigerant to be circulated. This may be accomplished by appropriate choice of compressor materials and/or coatings. Examples of compressors suitable for use with the heat pumps disclosed herein include, without limitation, screw compressors, scroll compressors, swing compressors, swash compressors, wobble plate compressors, or centrifugal blower compressors.

The refrigerant line may be any sort of piping capable of allowing a circulating refrigerant to pass to the various components of the heat pump to allow for the desired transfer of heat to and from the refrigerant. In some embodiments, the refrigerant line is configured to allow for the circulation of an R718 refrigerant. No particular type of refrigerant line is necessary to be used with the heat pumps disclosed herein, and a person of ordinary skill in the art may be capable of selecting appropriate refrigerant lines depending on the design specification of the heat pump.

The refrigerant condenser may be any condenser capable of condensing the refrigerant to allow for the transfer of heat from the refrigerant to the contaminated feedstock. In some embodiments, the condenser is configured to condense an R718 refrigerant and allow for the transfer of heat from the R718 refrigerant to the contaminate feedstock. The condenser may have a thin wall, high heat transfer coefficient, high surface area, or any combination thereof to facilitate the transfer of heat between the refrigerant to the contaminated feedstock. The condenser may also have high corrosion resistance for either or both of the refrigerant and the contaminated feedstock. High corrosion resistance may be accomplished by the choice of materials or coatings on the condenser.

The refrigerant evaporator may be any evaporator capable of evaporating the refrigerant to allow for the transfer of heat from water vapor to the refrigerant. In some embodiments, the evaporator is configured to evaporate an R718 refrigerant and allow for the transfer of heat from water vapor to the R718 refrigerant The evaporator may also have high corrosion resistance for either or both of the refrigerant and the water vapor. High corrosion resistance may be accomplished by the choice of materials or coatings on the evaporator. The evaporator may also have a surface finish to minimize the leaching of materials into the distillate from the evaporator if the highest purity distillates are desired. This may also be accomplished by the choice of materials or coating on the evaporator.

The throttle valve may be any throttle valve capable of reducing the pressure of the refrigerant and lowering the temperature of the refrigerant. In some embodiments, the throttle valve may be any throttle valve capable of reducing the pressure of an R718 refrigerant and lowering the temperature of the R718 refrigerant. In some embodiments, the throttle valve may be variable so that amount of refrigerant circulating to the evaporator can be controlled. Examples of throttle valves suitable for use with the heat pumps disclosed herein include, without limitation, capillary tubes, constant pressure throttling valves, thermostatic expansion valves, or float valves.

The subcooler may be any subcooler capable of reducing the temperature of the refrigerant. In some embodiments, subcooler may be capable of reducing the pressure of an R718 refrigerant and lowering the temperature of the R718 refrigerant. In some embodiments, the subcooler may transfer heat to the surround air. In other embodiments, the subcooler may transfer heat to a liquid. In particular embodiments, the subcooler may act as a preheater by transferring heat to the incoming contaminated feedstock prior to entering the distillation vessel.

The distillation vessel may be any distillation vessel configured to receive a contaminated feed stream, discharge the distillate, isolate the distillate from the contaminated feedstock, and house the refrigerant condenser and refrigerant evaporator. In some embodiments, the distillation vessel is insulated to reduce heat flow from the distillation vessel to the surrounding environment. In particular embodiments, the distillation vessel is vacuum walled to reduce heat transfer.

The heat exchanger may be any heat exchanges configured to transfer heat from the effluent line to the intake line to increase the temperature of the incoming contaminated feed stream. In some embodiments, the heat exchanger is a cross-flow heat exchanger, a parallel-flow heat exchanger, or a counter-flow heat exchanger.

The preheater may be any preheater configured to transfer heat from the refrigerant line to the intake line to increase the temperature of the incoming contaminated feed stream. In some embodiments, the preheater is a subcooler.

The circulator may be any circulator configured to increase the rate of migration of the water vapor to the refrigerant evaporator to cause the water vapor to condense into the distillate. In some embodiments, the circulator creates turbulence and/or convection to increase the rate of migration of the water vapor. In some embodiments, the circulator may also be used to modify the pressure within the distillation vessel or the pressure locally at the refrigerant condenser or evaporator. In particular embodiments, the circulator reduces the pressure at the refrigerant condenser to assist in evaporation and/or increases the pressure at the refrigerant evaporator to assist in condensation. Examples of circulators suitable for use with the devices disclosed herein include, without limitation, fans, blowers, and compressors.

All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

All references, including publications, patent application, and patents, cited herein are hereby incorporated by reference to the same extent as if each reference were individually and specifically indicated to be incorporated by reference and were set forth in its entirety.

Preferred aspects of this invention are described herein, including the best mode known to the inventors for carrying out the invention. Variations of those preferred aspects may become apparent to those of ordinary skill in the art upon reading the foregoing description. The inventors expect a person having ordinary skill in the art to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### EXAMPLES

### Example 1

An exemplary water purification system having a refrigerant condenser within a distillation vessel is described herein. A MasterFlux Sierra 02-0716Y3 Brushless DC variable speed compressor was used in a refrigeration loop further comprising a refrigerant evaporator coil and a refrigerant condenser coil, each constructed from copper pipping, and an expansion valve position between the coils. The condenser coil was arranged below the evaporator coil within a thermally-insulated distillation vessel and separated by a v-shaped trough configured to funnel distillate out a hole in the side of the distillation vessel. R134a was used as the refrigerant. The unit achieved a Figure of Merit (“FOM”) of 2300 W/kg/hr, where the FOM equals the rate of product water produced per input power consumed.

Addition of a circulator within the distillation vessel to move air around internally improved the FOM to 1800 W/kg/hr.

Addition of an external subcooler, modifying the refrigerant charge, and operating the condenser coil at a temperature of about 60° C. and the evaporator coil around 15° C. further improved the FOM to 425 W/kg/hr. By modifying the operational temperature we realized that the hotter the system was run, the more efficient it became.

### Example 2

An exemplary water purification system having a refrigerant condenser within a distillation vessel and using R718 refrigerant is described herein. The refrigeration loop comprises, in order, a scroll compressor typically used for an automotive air-conditioning system driven by a DC motor, a 20′ refrigerant condenser coil positioned with in an insulated distillation vessel, a preheater for exchanging heat between the refrigerant and feed stream entering the distillation vessel, a subcooler for exchanging heat between the refrigerant and a heat sink, a stainless steel hydraulic needle valve regulating refrigerant flow regulating refrigerant circulation between 1-2 gallon/hr, an automotive air-conditioning evaporator within the insulated distillation vessel. The refrigeration loop also comprises a relief circuit for bypassing the compressor, and a reservoir accumulator. The refrigerant is R718.

The purification system was operated in batch mode and feedstock was positioned in the insulated distillation vessel in contact with the refrigerant condensation coil. Heat from the refrigerant condenser vaporized a portion of the feedstock. A circulator fan capable of providing 530 ft³/hr of air flow between the refrigerant condenser and refrigerant evaporator allowed for distillate to be prepared.

### Example 3

An exemplary water purification system having a using a condensing liquid is described herein. The refrigeration loop comprises, in order, a scroll compressor typically used for an automotive air-conditioning system driven by a DC motor, a refrigerant condenser coil positioned with in an insulated distillation vessel, a preheater for exchanging heat between the refrigerant and feed stream entering the distillation vessel, a subcooler for exchanging heat between the refrigerant and a heat sink, a stainless steel hydraulic needle valve regulating refrigerant flow, and refrigerant evaporator outside the insulated distillation vessel configured to exchange heat with the condensing liquid. The refrigerant is R718.

The purification system also comprises an intake line providing the feed steam. The incoming feed stream exchanges heat with product distillate exiting the distillation vessel at a heat exchanger and the refrigerant at a preheater before entering the insulated distillation vessel and contacting the refrigerant condensation coil. The feedstock is warmed by the exchange of heat with the refrigerant at the condensation coil and a portion is vaporized. A circulator provides air flow between the refrigerant condenser and an incoming condensing liquid of recycled distillate. The distillate is divided into a portion of product distillate that exits the system and a second portion that is recycled back into the distillation vessel via the refrigerant evaporator to be used as the condensing liquid.

We claim:

1. A purification system comprising a heat pump, the heat pump comprises a refrigerant condenser, a refrigerant evaporator, a compressor, and a throttle valve,
wherein the refrigerant condenser, the refrigerant evaporator, and the throttle valve are fluidly connected with a circulating refrigerant along a refrigerant line, and
wherein the heat pump is configured for the circulating refrigerant to transfer heat to a contaminated feedstock at the refrigerant condenser and vaporize at least a portion of the contaminated feedstock.

2. The purification system of claim 1, wherein the heat pump is configured for the circulating refrigerant to receive heat from the vaporized contaminated feedstock at the refrigerant evaporator and condense at least a portion of vaporized contaminated feedstock to prepare a distillate.

3. The purification system of claim 1, wherein the heat pump is configured for the circulating refrigerant to receive heat from a condensing liquid at the refrigerant evaporator and prepare a chilled condensing liquid and wherein the system is configured for the chilled liquid to receive heat from the vaporized contaminated feedstock and condense at least a portion of the vaporized contaminated feedstock to prepare a distillate.

4. The purification system of any of claims 1-3 further comprising a distillation vessel,
wherein the refrigerant condenser is within the distillation vessel.

5. The purification system of claim 4, wherein the refrigerant evaporator is within the distillation vessel.

6. A purification system comprising:
(a) an intake line for providing a contaminated feed stream to a distillation vessel,
(b) a refrigerant condenser in thermal communication with the contaminated feed stream within the distillation vessel,
(c) a refrigerant evaporator, and
(d) an effluent line for removing a distillate from the distillation vessel.

7. The purification system of claim 6, wherein the refrigerant evaporator is in thermal communication with a vapor within the distillation vessel.

8. The purification system of claim 6, wherein the refrigerant evaporator is in thermal communication with a condensing liquid.

9. The purification system of claim 8, wherein the refrigerant evaporator is within the distillation vessel.

10. The purification system of claim 8, wherein the refrigerant evaporator is outside the distillation vessel.

11. A purification system comprising:
(a) a heat pump, the heat pump comprising:
(i) a refrigerant condenser in thermal communication with the contaminated feed stream within the distillation vessel,
(ii) a refrigerant evaporator,
(iii) a compressor configured to increase the internal energy of a circulating refrigerant, and
(iv) a throttle valve configured to decrease the internal energy of the circulating refrigerant,
(b) a distillation vessel,
(c) an intake line for providing a contaminated feed stream to the distillation vessel, and
(d) an effluent line for removing a distillate from the distillation vessel,
wherein the refrigerant condenser, the refrigerant evaporator, and the throttle valve are fluidly connected with the circulating refrigerant along a refrigerant line,
wherein heat from the circulating refrigerant at the refrigerant condenser is transferred to the contaminated feed stream to vaporize at least a portion of the contaminated feed steam, and
wherein the distillate is prepared from the condensation of at least a portion of the vapor within the distillation vessel.

12. The purification system of claim 11, wherein the refrigerant evaporator is within the distillation vessel,
wherein the refrigerant evaporator is in thermal communication with the vapor within the distillation vessel, and
wherein the system is configured for heat from the vapor within the distillation vessel to be transferred to the circulating refrigerant at the refrigerant evaporator to condense at least a portion of the vapor within the distillation vessel to prepare the distillate.

13. The purification system of claim 11, wherein the refrigerant evaporator is in thermal communication with a condensing liquid,
wherein the system is configured for heat from the condensing liquid to be transferred to the circulating refrigerant at the refrigerant evaporator to prepare a chilled condensing liquid, and
wherein the system is configured for heat from the vapor to be transferred to the chilled condensing liquid within the distillation vessel to condense at least a portion of the vapor to prepare the distillate.

14. A purification system comprising:
(a) a heat pump, the heat pump comprising:
(i) a refrigerant condenser in thermal communication with the contaminated feed stream within the distillation vessel,
(ii) a refrigerant evaporator within the distillation vessel in thermal communication with a vapor within the distillation vessel,
(iii) a compressor configured to increase the internal energy of a circulating refrigerant, and
(iv) a throttle valve configured to decrease the internal energy of the circulating refrigerant,
(b) a distillation vessel,
(c) a reverse osmosis system,
(d) an intake line for providing a contaminated feed stream to the reverse osmosis system,
(e) a line for providing a concentrate from the reverse osmosis system to the distillation vessel and
(f) an effluent line for removing a distillate from the distillation vessel,
wherein the refrigerant condenser, the refrigerant evaporator, and the throttle valve are fluidly connected with the circulating refrigerant along a refrigerant line,
wherein heat from the circulating refrigerant at the refrigerant condenser is transferred to the contaminated feed stream to vaporize at least a portion of the contaminated feed steam, and
wherein heat from the vapor within the distillation vessel is transferred to the circulating refrigerant at the refrigerant evaporator to condense at least a portion of the vapor within the distillation vessel to prepare the distillate.

15. The water purification system of claim 14, wherein a permeate from the reverse osmosis system is mixed with the distillate.

16. The purification system of any of the previous claims further comprising a heat exchanger,
wherein the heat exchanger is positioned along the intake line and the effluent line and
wherein the heat exchanger is configured to exchange heat from the distillate to the contaminated feed stream.

17. The purification system of any of the previous claims further comprising a preheater,
wherein the preheater is positioned along the intake line and the refrigerant line and
wherein the preheater is configured to exchange heat from the circulating refrigerant to the contaminated feed stream.

18. The purification system of any of the previous claims, wherein the preheater is position along the intake line between the distillation vessel and the heat exchanger.

19. The purification system of any of the previous claims further comprising a subcooler positioned along the refrigerant line.

20. The purification system of any of the previous claims further comprising a circulator within the distillation vessel.

21. The purification system of any of the previous claims, wherein the distillation vessel is thermally insulated.

22. The purification system of any of the previous claims, wherein the circulating refrigerant comprises a refrigerant selected from the group consisting of water, 1,1,1,2-tetrafluoroethane, 1,1,1,3,3-pentafluoropropane, ammonia, isobutene, and 1,1,1,3,3,3-hexafluoropropane.

23. The purification system of any of the previous claims, wherein the condensing liquid comprises water.

24. The purification system of any of the previous claims, wherein the condensing liquid comprises the distillate.

25. The purification system of any of the previous claims, wherein the refrigerant condenser is at a temperature of about 50° C. to about 150° C.

26. The purification system of any of the previous claims, wherein the refrigerant evaporator is at a temperature of about 5° C. to about 100° C.

27. The purification system of any of the previous claims, wherein the contaminated feed stream is a contaminated aqueous feed stream.

28. The purification system of any of the previous claims further comprising a venting line.

29. The purification system of any of the previous claims further comprising a drain line.

30. The purification system of any of the previous claims further comprising a liner.

31. A method of purifying a contaminated feed stream comprising:
(a) transferring heat from a circulating refrigerant to the contaminated feed stream at a refrigerant condenser to vaporize at least a portion of the contaminated feed stream within a distillation vessel and
(b) condensing at least a portion of the vapor to prepare a distillate.

32. The method of claim 31, wherein heat from the vapor is transferred to the circulating refrigerant at the refrigerant evaporator within the distillation vessel.

33. The method of claim 31, wherein heat from the vapor is transferred to a chilled condensing liquid within the distillation vessel.

34. The method of claim 33, wherein the refrigerant evaporator is within the distillation vessel.

35. The method of claim 33, wherein the refrigerant evaporator is outside the distillation vessel.

36. The method of any of claims 31-35 further comprising providing a purification system as in any of claims 1-30.

37. The method of any of claims 31-36 further comprising transferring heat from the distillate to the contaminated feed stream at a heat exchanger.

38. The method of any of claims 31-37 further comprising transferring heat from the circulating refrigerant to the contaminated feed stream at a preheater.

39. A method of purifying a contaminated feed stream comprising:
(a) contacting the contaminated feed stream with a refrigerant condenser to vaporize at least a portion of the contaminated feed stream and
(b) condensing at least a portion of the vapor to prepare a distillate.

40. The method of claim 39 further comprising providing a purification system as in any of claims 1-30.

41. The method of any of claims 39-40 further comprising contacting the contaminated feed stream with a heat exchanger.

42. The method of any of claims 39-41 further comprising contacting the contaminated feed stream with a preheater.

43. A washing system comprising a washer and a water-purification system, wherein the water-purification system comprises a heat pump,
wherein the washing system is configured to receive purified water from the water purification system, and
wherein the water-purification system is configured to receive contaminated water from the washer.

44. The washing system of claim 43, wherein the water purification system is a water purification system as in any of claims 1-30.

45. The washing system of claim 43 or 44, further comprising a storage tank.

46. The washing system of claim 45, wherein the washing system comprises at least two storage tanks.

47. A method for the cleaning of clothes or other soiled items, the method comprising washing the clothes or other soiled items with a washing system,
wherein the washing system comprises a washer and a water-purification system, and
wherein the water purification system comprises a heat pump.

48. The method of claim 47, wherein the water purification system is a water purification system as in any of claims 1-30.

49. The method of claim 47, wherein the washing system is a washing system as in any of claims 43-46.

50. A washing and drying system comprising a washer, a dryer, and a water-purification system, wherein the water-purification system comprises a heat pump,
wherein the washing system is configured to receive purified water from the water purification system,
wherein the water-purification system is configured to receive contaminated water from the washer, and
wherein heat is transferred from the heat pump to the dryer.

51. The washing and drying system of claim 50, wherein the water purification system is a water purification system as in any of claims 1-30.

52. The washing and drying system of claim 50-51, further comprising a storage tank.

53. The washing and drying system of claim 51, wherein the washing system comprises at least two storage tanks.

54. The washing and drying system of any of claims 50-53 further comprising a second refrigerant condenser and a second refrigerant evaporator.

55. A method for the cleaning and drying of clothes or other soiled items, the method comprising washing the clothes or other soiled items with a washing and drying system and drying the clothes or other soiled items with the washing and drying system,
wherein the washing and drying system comprises a washer, a dryer, and a water-purification system, and
wherein the water purification system comprises a heat pump.

56. The method of claim 55, wherein the water purification system is a water purification system as in any of claims 1-30.

57. The method of claim 55, wherein the washing and drying system is a washing and drying system as in any of claims 50-54.
